(19) United States
(12) Patent Application Publication
(10) Pub. No.: US 2013/0269575 A1
(43) Pub. Date: Oct. 17, 2013

(54) BANKING MACHINE

(71) Applicant: Chang Jin Lee, Seoul (KR)

(72) Inventor: Chang Jin Lee, Seoul (KR)

(73) Assignee: LG CNS CO., LTD., Seoul (KR)

(21) Appl. No.: 13/978,356

(22) PCT Filed: Jan. 4, 2012
(86) PCT No.: PCT/KR2012/000095

§ 371 Date: Jul. 3, 2013

(30) Foreign Application Priority Data
Jan. 5, 2011 (KR) 10-2011-0000782

(51) Int. Cl. E05G 1/06

(52) U.S. Cl. CPC E05G 1/06
USPC 109/24

(57) ABSTRACT

Provided is a financial device. The financial device includes a medium depositing and withdrawal unit for allowing media to be deposited or withdrawn, a discrimination unit sensing media to be deposited or withdrawn, one or more medium storage boxes storing media deposited through the medium depositing and withdrawal unit or media to be withdrawn through the medium depositing and withdrawal unit, a collection storage box for storing media determined by the discrimination unit as bad media or media that are not picked up by a customer, and a single safety box containing the one or more medium storage boxes and the collection storage box for security.

### TECHNICAL FIELD

The present invention relates to a financial device.

### BACKGROUND ART

Generally, financial devices process financial tasks that customers want. Financial devices may allow media to be deposited or withdrawn or automatically transfer media. For example, financial devices may allow paper money or checks to be deposited or withdrawn.

Financial devices may include a medium deposition and withdrawal unit, one or more medium storage boxes storing normal media, and a collection box storing bad media or media that customers do not receive.

According to locations where financial devices are installed, a safety box for protecting one or more medium storage boxes and the collection box may be installed.

However, in the case of general financial devices, since media storage boxes and the collection box are disposed in locations separated from one another, it is necessary to install safety boxes in respective locations where medium storage boxes and the collection box are located.

### DISCLOSURE OF THE INVENTION

### Technical Problem

The present invention provides a financial device in which a medium storage box and a collection box are located together with one another in a safety box in such a way that space availability increases and costs for installing the safety box is reduced.

### Technical Solution

According to an aspect of the present invention, there is provided a financial device. The financial device includes a medium depositing and withdrawal unit to allow a medium to be deposited or withdrawn, a discrimination unit sensing a medium to be deposited or withdrawn, one or more medium storage boxes to store a medium deposited through the medium depositing and withdrawal unit or a medium to be withdrawn through the medium depositing and withdrawal unit, a collection storage box to store a medium determined by the discrimination unit as a bad medium or a medium that are not picked up by a customer, and a single safety box to accommodate the one or more medium storage boxes and the collection storage box for security.

According to another aspect of the present invention, there is provided a financial device. The financial device includes a safety box for security, a medium depositing and withdrawal unit provided outside the safety box to allow a medium to be deposited or withdrawn, a discrimination unit provided outside the safety box and to sense a medium to be deposited or withdrawn, one or more medium storage boxes accommodated in the safety box and to store a medium deposited through the medium depositing and withdrawal unit or a medium to be withdrawn through the medium depositing and withdrawal unit, a collection storage box accommodated in the safety box to store a medium determined by the discrimination unit as a bad medium or a medium that are not picked up by a customer, a transfer unit accommodated in the safety box to transfer a medium to the collection storage box, and a transfer path disposed outside the safety box, through which a medium to be distributed to the one or more medium storage boxes and the transfer unit are transferred.

### ADVANTAGEOUS EFFECTS

According to the present embodiment, since a collection storage box and a medium storage box are received in a single safety box, the cost of the safety box and the cost for installing the safety box may be reduced. Also, the collection storage box is located in a side of the medium storage box, thereby increasing space availability of the inside of a financial device.

Also, since bad media and media that are not received may be stored together in a single collection storage box, a time for withdrawing or depositing the collection storage box may be reduced and convenience of a manager may be improved.

### BRIEF DESCRIPTION OF THE DRAWINGS

FIG. 1 is a configuration view illustrating a financial device according to an embodiment of the present invention; and

FIG. 2 is a view illustrating a transfer path for collecting media in the financial device of FIG. 1.

### MODE FOR CARRYING OUT THE INVENTION

Hereinafter, the embodiments of the present invention will be described in detail with reference to the attached drawings. Throughout the drawings, like reference numerals designate like elements. Also, in describing the embodiments of the present invention, a detailed description of well-known elements or functions of related art, which disturbs understanding the embodiments, will be omitted.

Also, in describing elements of the embodiments, terms like “a first”, “a second”, “A”, “B”, “(a)”, “(b)” may be used. The terms are merely to distinguish elements from one another, and the definition, sequence, and order of corresponding elements are not limited thereto. When it is disclosed that one element is “connected to” or “coupled with” another element, the one element may be directly connected to or coupled with the other element but it may also be understood that the respective element may be connected to or coupled with each other with still another element intervening therebetween.

A financial device according to an embodiment of the present invention performs financial tasks of processing media, for example, performing processes of making a deposit, receipt by giro, exchange of gift certificates and/or processes of making a withdrawal, giro discharge, and certificate discharge by obtaining various media such as paper money, securities including checks, giro, coins, and gift certificates. As an example of the financial device, there is an automated teller machine (ATM) such as a cash dispenser and a cash recycling device.

However, the financial device is not limited thereto but may include various devices of automating financial tasks such as a financial information system.

Hereinafter, a case in which the financial device is an ATM will be described. Merely, this is just for convenience of description and the scope of the present invention is not limited to the ATM.

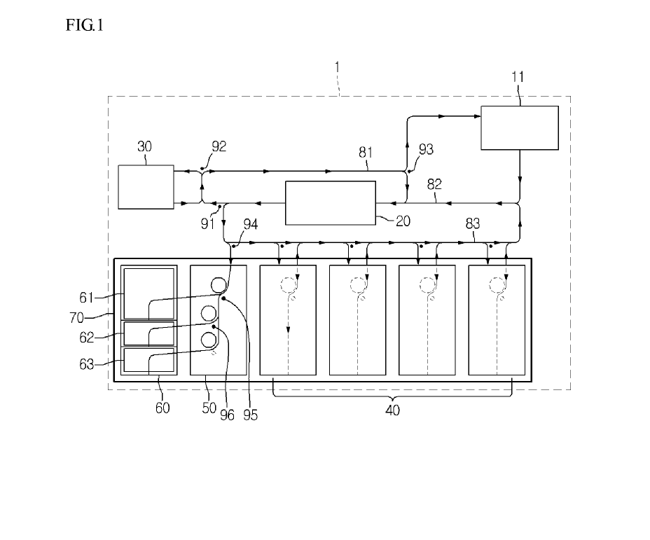

FIG. 1 is a configuration view illustrating a financial device 1 according to an embodiment of the present invention.

Referring to FIG. 1, the financial device 1 includes a medium depositing/withdrawing unit 11. The medium depositing/withdrawing unit 11 includes a medium storage space allowing a customer to access, which may be opened and closed by a shielding element such as a shutter or a cover and may occasionally be maintained as being opened. Also, medium depositing/withdrawing unit 11 may include a pickup element for separating and transferring a medium one by one from the medium storage space while the customer is depositing media and an accumulation element for accumulating media transferred while the customer is withdrawing the media.

Also, the financial device 1 may further include a discrimination unit 20. The discrimination unit 20 may include a sensing element for identifying the kind of media or distinguishing and separating bad media while media are deposited or withdrawn. The discrimination unit 20 senses the size and color of a medium or a condition of an image to identify the kind of the medium or to distinguish a bad medium.

Also, the financial device 1 may further include a temporary stacker 30. The temporary stacker 30 temporarily stacks, when the customer wants to deposit media in the financial device 1, the media received through the medium depositing/withdrawing unit 11. The media accumulated in the temporary stacker 30 are transferred to a medium storage box 40 that will be described below when the customer finally determines media deposition.

Also, the financial device 1 may further include one or more medium storage boxes 40. The medium storage box 40 stores normal media that are not distinguished as bad media by the discrimination unit 20. Also, when a medium withdrawal command is inputted, accumulated media may be withdrawn from the medium storage box 40.

The medium storage box 40 may be formed with a medium inlet for allowing transferred media to be deposited and a medium outlet for allowing media accumulated in the medium storage box 40 to be discharged outwardly. Generally, the medium inlet and the medium outlet may be formed on a top of a box forming an exterior of the medium storage box 40.

Also, in the medium storage box 40, a medium accumulation element for allowing media transferred from the outside to be accumulated side by side and a medium pickup element separating the accumulated media one by one and transferring the media outwardly may be provided together. Since a detailed configuration as described above has been already known, a detailed description thereof will be omitted.

The medium storage box 40 may be formed lengthways in a direction parallel to a direction of gravity to allow media to be accumulated in the direction of gravity and may be disposed on a bottom in the financial device 1. When the financial device 1 includes a plurality of medium storage boxes 40, the plurality of medium storage boxes 40 may be arranged horizontally. Otherwise, the plurality of medium storage boxes 40 may be arranged vertically.

Also, the financial device 1 includes a collection storage box 60 for storing bad media and the like and a transfer unit 50 for transferring media to the collection storage box 60.

In the collection storage box 60, a plurality of collection parts 61, 62, and 63 divided vertically may be provided. The plurality of collection parts 61, 62, and 63 may include a first collection part 61, a second collection part 62, and a third collection part 63.

In the first collection part 61, media distinguished by the discrimination unit 20 as bad ones while a medium withdrawal operation is being performed may be accumulated. In the second collection part 62, media distinguished by the discrimination unit 20 as bad ones while the accumulated media in the media storage box 40 are being withdrawn may be accumulated. In the third collection part 63, during a medium withdrawal process, when a user inputs a medium withdrawal command and media withdrawn to the medium depositing and withdrawal unit 11 are not picked up for more than a certain time, the media withdrawn to the medium depositing and withdrawal unit 11 may be collected and stored.

In the present embodiment, the plurality of collection parts 61, 62, and 63 may be spaces formed by dividing the inside of the collection storage box 60 or may be individual storage boxes received in the collection storage box 60.

The collection storage box 60 includes a plurality of medium inlets allowing media to be accepted into the plurality of collection parts 61, 62, and 63, respectively. The collection parts 61, 62, and 63 may be provided with medium accumulation elements for allowing media to be accumulated, respectively. When the respective collection parts 61, 62, and 63 are individual storage boxes received in the collection storage box 61, the collection parts 61, 62, and 63 may be formed with medium inlets, respectively.

Media to be transferred to the collection storage box 60 are transferred to the transfer unit 50 and then are distributed to one of the plurality of collection parts 61, 62, and 63. In this case, since the plurality of collection parts 61, 62, and 63 are arranged vertically, the medium inlets may be provided on a side surface of the medium storage box 60 or on side surfaces of the collection parts 61, 62, and 63, respectively. As another example, when the plurality of collection parts 61, 62, and 63 are arranged laterally, the medium inlets may be provided on a top surface of the medium storage box 60 or on top surfaces of the collection parts 61, 62, and 63, respectively.

The transfer unit 50 includes one medium inlet allowing media to be accepted and a plurality of medium outlets allowing media to be discharged. The plurality of medium outlets may be arranged vertically.

The medium storage box 40, the transfer unit 50, and the collection storage box 60 may be horizontally arranged in a line as an example as shown in the drawing. That is, the medium storage box 40, the transfer unit 50, and the collection storage box 60 may be arranged side by side.

With the arrangement as described above, the medium storage box 40, the transfer unit 50, and the collection storage box 60 may be located in a single safety box 70. That is, it is unnecessary to provide a safety box for the collection storage box 60 in addition to a safety box for the medium storage box 40. The medium storage box 40, the transfer unit 50, and the collection storage box 60 may be located together in the single safety box. The safety box 70 is disposed on the bottom in the financial device 1. As another example, the plurality of medium storage boxes 40, the collection parts 61, 62, and 63 may be arranged horizontally and the transfer unit 30 may be located above the collection parts 61, 62, and 63 in the safety box 70.

Although not shown in FIG. 1, the safety box 70 is formed with one or more first medium inlets allowing media to be transferred to the medium storage box 40, a second medium inlet allowing the media to be accepted into the transfer unit 50, and one or more medium outlets allowing the media in the medium storage box 40 to be discharged.

Also, the financial device 1 may further include a plurality of transfer paths allowing media to be transferred. The plurality of transfer paths include a first transfer path 81 located above the discrimination unit 20, a second transfer path 82 passing through the discrimination unit 20, and a third transfer path 83 located below the discrimination unit 20. The respective transfer paths 81, 82, and 83 are located outside the safety box 70.

The third transfer path 83 is located above the medium storage box 40, the transfer unit 50, and the collection storage box 60, and media transferred along the third transfer path 83 are distributed to one of the medium storage box 40 and the transfer unit 50. That is, the media on the third transfer path are distributed to one of the medium storage box 40 and the transfer unit 50 by one or more diverters.

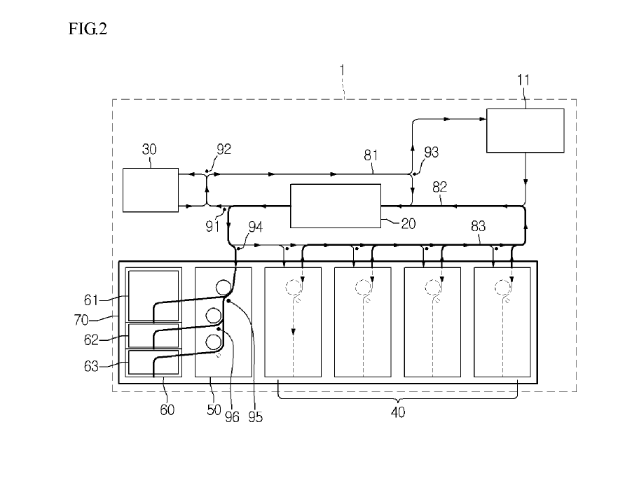

FIG. 2 is a view illustrating a transfer path for collecting media in the financial device of FIG. 1. Before description, on the transfer path provided in the financial device 1, there is provided a plurality of diverters for controlling a transfer direction of media when two or more paths are diverged from one path. The diverters are shown as dots in FIG. 2.

Referring to FIG. 2, when depositing media, the media are accepted into the medium depositing and withdrawal unit 11. The medium depositing and withdrawal unit 11 separates the media one by one and transfers the media to the discrimination unit 20. The media passing the discrimination unit 20 are transferred to a second diverter 92 by a first diverter 91. Next media are transferred to the temporary stacker 30 by the second diverter 92. Merely, media distinguished by the discrimination unit 20 to be bad ones move from the second diverter 92 along the first transfer path 81 to a right direction and return to the medium depositing and withdrawal unit 11.

While media are accumulated in the temporary stacker 30 and the user finally determines media deposition, the media accumulated in the temporary stacker 30 are transferred toward the third diverter 93 by the second diverter 92. The media transferred toward the third diverter 93 are transferred to the discrimination unit 20 by the third diverter 93. The discrimination unit 20 determines the kind of media or whether the media are damaged or not or are bad or not. Normal media are transferred to right by a fourth diverter 94 at an entrance of the third transfer path 83 and are accumulated in the medium storage box 40 after passing the safety box 70. On the contrary, bad media are transferred from the fourth diverter 94 to the transfer unit 50. The bad media transferred to the transfer unit 50 are transferred to the first collection part 61 by a fifth diverter 95.

On the other hand, when withdrawing media, the media are picked up one by one from the medium storage box 40, are discharged outwardly from the medium storage box 40, and are transferred to the discrimination unit 20 along the third transfer path 83 and the second transfer path 82. The discrimination unit 20 senses whether damages, counterfeits, and defects of the media exist, and media distinguished as bad ones are transferred downwardly by the first diverter 91 and are transferred to the transfer unit 50 by the fourth diverter 94. Also, the bad media transferred to the transfer unit 50 are transferred to the second collection part 62 by the fifth diverter 95 and a sixth diverter 96. Differently, media determined by the discrimination unit 20 as normal ones are transferred to the first transfer path 81 and are transferred to the medium depositing and withdrawal unit 11 by the third diverter 93.

On the other hand, in the case of withdrawing media as described above, when the media are transferred to the medium depositing/withdrawing unit 11 but the customer does not receive the media, the media transferred to the medium depositing and withdrawal unit 11 may pass the discrimination unit 20, may be transferred to the transfer unit 50, and may be transferred to the third collection part 63 by the fifth diverter 95 and the sixth diverter 96.

According to the present embodiment, the cost of the safety box and the cost for installing the safety box may be reduced. Also, the collection storage box is located on the side of the medium storage box, thereby increasing space availability of the inside of the financial device.

Also, since bad media and media that are not picked up may be stored together in a single collection storage box, a time for withdrawing or depositing the collection storage box may be reduced and convenience of a manager may be improved.

Also, since the respective transfer paths 81, 82, and 83 are located outside the safety box 70, when a safety box is not necessary, the safety box is removed and other elements except the safety box may be used with no change, thereby allowing common use of parts to be possible and also effectively managing manufacturing processes.

In the above, it has been described that elements are coupled with one another into one or operate while being coupled with one another. However, the present invention is not limited thereto. That is, within a range of the purpose of the present invention, all elements may selectively be coupled with one another and may operate while being coupled with one another.

Also, terms such as “include”, “be configured to”, or “have”, as there is no mention contrary thereto, mean that a corresponding element may exist, which should be understood as not excluding other elements but capable of further including other elements. All terms including technical or scientific terms, if not defined differently, have the same meaning generally understood by those of ordinary skill. Terms generally used as terms defined in dictionaries should be understood as being identical to contextual meanings of related art and are analyzed not to be ideal meanings or not to be excessively perfunctory meanings if not clearly defined in the description.

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

1. A financial device comprising:
a medium depositing and withdrawal unit to allow a medium to be deposited or withdrawn;
a discrimination unit to sense a medium to be deposited or withdrawn;
one or more medium storage boxes to store a medium deposited through the medium depositing and withdrawal unit or a medium to be withdrawn through the medium depositing and withdrawal unit;
a collection storage box to store media determined by the discrimination unit as a bad medium or a medium that are not picked up by a customer; and
a single safety box to accommodate the one or more medium storage boxes and the collection storage box for security.

2. The financial device of claim 1, further comprising a transfer unit accommodated in the safety box to transfer a medium to the collection storage box.

3. The financial device of claim 2, wherein the collection storage box, the one or more medium storage boxes, and the transfer unit are horizontally arranged in the safety box.

4. The financial device of claim 2, wherein the collection storage box and the one or more medium storage boxes are horizontally arranged in the safety box, and
wherein the collection storage box and the transfer unit are vertically arranged in the safety box.

5. The financial device of claim 2, further comprising a transfer path provided outside the safety box, through which the media to be deposited in the safety box or the media withdrawn from the safety box are transferred.

6. The financial device of claim 5, wherein the transfer path comprises:
a first transfer path located above the discrimination unit;
a second transfer path passing through the discrimination unit; and
a third transfer path located below the discrimination unit and above the safety box.

7. The financial device of claim 6, wherein a medium on the third transfer path are deposited in the safety box or a medium in the safety box are withdrawn to the third transfer path.

8. The financial device of claim 2, wherein the safety box comprises:
one or more first medium inlets to allow a medium to be transferred to the one or more medium storage boxes;
a second medium inlet to allow a medium to be transferred to transfer unit; and
one or more medium outlets to allow a medium to be withdrawn from the one or more medium storage boxes.

9. The financial device of claim 2, wherein the collection storage box comprises a plurality of collection parts to allow a medium to be stored while being distinguished according to conditions of the medium, and
wherein the transfer unit comprises a plurality of diverters to distribute a medium to the plurality of collection parts.

10. A financial device comprising:
a safety box for security;
a medium depositing and withdrawal unit provided outside the safety box to allow a medium to be deposited or withdrawn;
a discrimination unit provided outside the safety box to sense a medium to be deposited or withdrawn;
one or more medium storage boxes accommodated in the safety box and to store a medium deposited through the medium depositing and withdrawal unit or media to be withdrawn through the medium depositing and withdrawal unit;
a collection storage box accommodated in the safety box to store a medium determined by the discrimination unit as a bad medium or a medium that are not picked up by a customer;
a transfer unit accommodated in the safety box to transfer a medium to the collection storage box; and
a transfer path disposed outside the safety box, through which a medium to be distributed to the one or more medium storage boxes and the transfer unit are transferred.
